(19) United States
(12) Patent Application Publication
(10) Pub. No.: US 2024/0083278 A1
(43) Pub. Date: Mar. 14, 2024

(54) DEPLOYABLE ELECTRIC VEHICLE CHARGING POINT

(71) Applicant: Albright Product Design Limited, Gloucestershire (GB)

(72) Inventor: Andrew Aylesbury, Gloucestershire (GB)

(21) Appl. No.: 18/375,040

(22) Filed: Sep. 29, 2023

Related U.S. Application Data
(63) Continuation-in-part of application No. 17/792,469, filed on Jul. 13, 2022.

(30) Foreign Application Priority Data
Jan. 13, 2020 (GB) 2000469.3

(51) Int. Cl. B60L 53/31

(52) U.S. Cl. CPC B60L 53/31

(57) ABSTRACT

A deployable electric vehicle charging point comprising a housing for burying substantially below ground level, a post and a power distribution connector mounted to the post; the post being mounted in the housing about a pivotal axis and movable about the pivotal axis between an in-operative position within the housing and operative position.

### CROSS REFERENCE TO RELATED APPLICATIONS

This application is a continuation in part of U.S. patent application Ser. No. 17/792,469 filed on Jul. 13, 2022 and currently pending, which is a National Stage application of PCT/GB21/50075 filed on Jan. 13, 2021, which claims the benefit of Great Britain patent application NO. GB 2000469.3, filed on Jan. 13, 2020.

### BACKGROUND OF THE INVENTION

### Field of the Invention

The present invention relates to a deployable electric vehicle charging point.

### Background

It is known to provide electric charging points for electric vehicles. These points are typically installed in a street, at home, an industrial area or at a service area, for example, at a motorway service station. Councils also install charging points in carparking areas in towns.

Sometimes it is beneficial to provide a charging point which is stored underground, when not being used, and which deploys to an above ground position for use. This is beneficial to reduce visual street clutter. Furthermore, this removes a permanent fixture, which may be regarded as an obstacle to pedestrians and traffic. Often, charging points are used overnight, and so there is an advantage in being able to store the charging point underground when not in use.

Storing a charging point underground when not in use also reduces the risk of vandalism or damage caused by a collision.

A problem of existing deployable electric vehicle charging points is that they deploy vertically from their base or underground containment. Typically, the charging connection is provided on a post, which is driven upwardly out of the ground from the base unit. This means that if the charging point is situated on a sloping surface, be it a road or pavement, then the charging point will not deploy vertically, but at an angle. If it is to be deployed vertically, then this creates difficulties in installing the base unit.

A further difficulty with installing the base unit is the depth at which excavations have to be made to accommodate the base unit. There are many existing groundworks, such as utility conduits, cables or sewers, which may have to be disturbed or may completely prevent a deployable charging point from being installed.

Furthermore, the cabling to the charging components has to be routed around the base unit. The cables may be forced to move or bend thought tight angles which is particularly problematic for higher capacity charging as the cables are much larger in diameter and more rigid.

It is an object of the present invention to reduce or substantially obviate the aforementioned problems

### SUMMARY OF THE INVENTION

According to the present invention there is provided a deployable electric vehicle (EV) charging point comprising a housing for burying substantially below ground level, a post and a power distribution connector mounted to the post; the post being mounted in the housing about a pivotal axis and movable about the pivotal axis between an inoperative or stowed position within the housing and an operative position, wherein the post is deployed substantially vertically in the operative position irrespective of the incline of the housing for enabling the electric vehicle charging point to be installed on an incline.

The power distribution connector is typically a socket for receiving a plug of an electric vehicle charging cable.

Advantageously, if the housing is buried and lies flush with the ground surface, for example on a street which is not level, i.e. on a hill, then it is possible to ensure that the post, in its operative position, is substantially plumb (or vertical) while also removing unnecessary street furniture and visual clutter. In the operative position, the post may be substantially vertical irrespective of the incline of the housing to the horizontal and the ground level.

The post may generally be considered a pivotally deployable post.

The deployable EV charging point may include a drive means to move the post between the inoperative and operative positions.

The drive means may include an electric motor.

The drive means may include a linear actuator.

The deployable EV charging point may include a transmission means between the drive means and the post. The transmission means may include a worm drive.

Transmission means may be provided for enabling the speed of post deployment to be controlled. Additionally, by the worm drive being self-locking, it is possible to hold the operative position of the post at the desired angle. For example, the worm-drive may be stopped in a particular position.

The central axis of the power distribution connector may be positioned at an angle to the post. The angle may be between 20 degrees and 70 degrees, preferably between 30 and 60 degrees, and more preferably between 40 and 50 degrees.

An angled power distribution connector may serve to reduce the stress on the connected cable, particularly thicker cables used for fast charging. Furthermore, it is easier and more intuitive than horizontal or vertical connections.

Preferably, the post has first and second lateral sides, and the axis on which the post pivots extends between the first and second lateral sides. The post has a front-facing side, and it is on the front-facing side that the power distribution connector is disposed. In the inoperative/stowed position, the front-facing side is disposed inside the housing and faces downwards (or, towards the bottom of the housing bearing in mind that the housing may be installed on an incline), so that it cannot be accessed and is protected from damage. The post has a rear-facing side which is preferably substantially flat. In the inoperative/stowed position, the rear-facing side forms a continuation of a pavement or road surface. A suitable non-slip surface may be provided on the rear-facing side to provide a surface which is safe to walk over or, in some embodiments, even drive vehicles over.

Preferably, the forward-facing side of the post has a front surface which in the stowed position contacts the bottom of the housing (or, contacts a part which in turn contacts the bottom of the housing). This prevents a force on the rear-facing side of the post (for example from somebody standing on or walking over the rear-facing side) from being transmitted to the transmission means, which might otherwise damage the transmission means. By contacting the forward-facing side against the bottom of the housing, the bottom of the housing (which in turn is likely to be installed in solid ground) provides a reaction to any downward force on the post.

Preferably, the power distribution connectors are inset from the part of the forward-facing side of the post which contacts the bottom of the housing in the stowed position. Thus the power distribution connector(s) are protected from damage by contacting any other part while stowed or while in the process of being stowed.

A plate may be provided for covering the housing when the post is in the operative position. The housing is preferably inset into the ground when installed, and has an open upper end for accepting the post when the post needs to be stowed. The purpose of the plate is to cover the open upper end of the housing when the post is deployed, so that the plate provides a surface substantially continuous with the pavement/road surface, upon which it is safe to walk or (in some embodiments) drive vehicles.

The plate may automatically cover the housing when the post is moved to the operative position. The plate may move from a position within the housing to a position at the upper end of the housing as the post moves from the inoperative to the operative position and vice versa.

Advantageously, the plate may cover an opening at street level which may reduce risk and improve health and safety. It may also ensure that foreign matter, such as leaves, refuse and similarly sized items are not able to enter the housing.

A mechanical coupling means may be provided between the post and the plate to move the plate from the position within the housing to a position at the upper end of the housing as the post moves from the inoperative to the operative position and vice versa.

The upper end of the housing is the end closest to the surface when the housing is buried. In other words, the upper end is the end of the housing which comprises an opening out of which the post is pivotally deployed.

The coupling means may include an arm pivotally attached to the post. The arm may comprise a pin for locating in an elongate recess or slot in the plate. The recess may run along a lateral side of the plate.

The operative position of the post is generally vertical and may be perpendicular or at another angle, acute or obtuse relative to the upper edge of the housing, dependent on the lie of the ground relative to the horizontal.

Preferably, the position of the pin along the arm is adjustable or selectable. In one embodiment, a number of threaded holes are provided at different positions along the arm, and the pin can be screwed into any selected one of the threaded holes. In this way, the effective length of the arm between the plate and the post can be altered. Upon installation, the position of the pin on the arm can be set so that when the post is in a vertical position (which will involve a different amount of pivoting in different installations, since the housing is installed parallel to the street surface which is not always horizontal) the plate will be lifted to a position at the upper end of the housing, substantially flush with the surface of the street. Providing multiple positions for the pin on the arm is an extremely simple way of providing flexibility for different installation environments. It does not require accurate measurement of the amount of slope beforehand since the installer can simply move the post to a vertical position, and then select the correct hole in the arm into which the pin is screwed.

The post in the deployed position is always substantially vertical, irrespective of the angle of incline (if any) of the pavement/road in which the housing is buried, and therefore the angle of incline of the housing. In different embodiments, this may be achieved for example by a gravity sensor which detects when a vertical position is reached on deployment and then stops the post from pivoting further. In other embodiments, a limit switch may be provided. Where the plate is provided as described above, it may be convenient to position a limit switch to detect when the plate has reached a position flush with the pavement surface, and then turn off drive means to prevent the post from moving further. As described above, the effective length of the arm between the plate and the post can be adjusted (for example by fixing a pin at a selected one of a plurality of different attachment positions). The limit switch, which may be for example a hall-effect sensor which has no exposed moving parts and can be protected from damage, can be factory fitted in one place to detect the position of the plate, and does not need to be adjusted.

A further alternative means of ensuring vertical deployment is to store electronically a value which can then be used by the drive means to reliably deploy the post to a predetermined position. For example, if a stepper motor is used to drive deployment then the post can be driven to a predetermined angle. Or, a motor of known speed could be switched on for a predetermined time according to the stored value.

The length of the housing may be greater than the height of the housing. When buried, the housing may extend further laterally than in depth below the ground.

The housing may generally be cuboid in shape with an opening in one of the faces. The opening is in the upper face, which when installed is substantially flush with the surface of the pavement or road.

The deployable EV charging point may be a connected device. The deployable EV charging point may comprise a communication means for communicating with a computer network. The communication means allows the charging point to be monitored remotely. The communication means may provide for a signal to be sent to the EV charging point to deploy, for example so that a driver can park in a space and then control deployment of the charging post from their mobile phone. This is firstly convenient for the driver, who can remain in the vehicle until the charging point is deployed and ready for use, which is welcome especially in bad weather. Secondly, it avoids the need to provide any controls which are accessible on the charger when it is in the stowed position. The charger in the stowed position need not have anything at all which is exposed and vulnerable to damage.

The deployable EV charging point may comprise an impact detection means for detecting, measuring and recording a received impact. The impact detection means may be an accelerometer. The charging point may comprise means, for example load cells, for detecting whether anything is on top of the charger when it is in the stowed position.

The deployable EV charging point may comprise an alarm means for altering persons within the vicinity. The alarm means may include a speaker. The alarm means may include illumination means, such as LEDs. Preferably, the alarm may sound for a predetermined period before the charging point deploys.

Where the deployable charging point is operated remotely, various protections may be desirable to ensure that the charging point cannot unexpectedly deploy and injure somebody in the vicinity. For example, the charging point may be deployable only when the controller (e.g. a mobile phone) is within a predetermined distance of the charging point. This may be achieved for example by requiring the GPS position of the controlling mobile phone to be within a radius of a known position of the charging point, before the function to deploy the charging point is activated on the device. Another protection is the use of an alarm, as described. Accelerometers, load cells, microphones, cameras, and other sensors may be used to detect people, animals, objects and activity on or in the vicinity of the charging point, and deployment may be inhibited for example if it is detected that somebody may be standing on the rear surface of the post.

The deployable electric vehicle charging point may comprise a monitoring means for monitoring the area around the deployable electric vehicle charging point.

The monitoring means may include a camera disposed in the post. The camera may be an omnidirectional camera or include a wide field of view. A first camera may be disposed on the post so as to provide a view external to the deployable EV charging point when the post in in the in-operative position.

The monitoring means may include a microphone. The monitoring system may include an array of microphones disposed in the post and/or the housing.

The deployable EV charging point may comprise a heater for warming the post and/or housing. This may ensure that the charger can deploy even in freezing temperatures which might otherwise affect the operation of the deployment mechanism.

The deployable EV charging point may comprise an air pollution sensor.

The deployable EV charging point may comprise a charging cable holding means disposed on the post for securing at least a portion of an electric vehicle charging cable

### BRIEF DESCRIPTION OF SEVERAL VIEWS OF THE DRAWINGS

For a better understanding of the present invention, and to show more clearly how it may be carried into effect, reference will now be made by way of example only to the accompanying drawings, in which:

FIG. 1 shows a perspective view of an electric vehicle charging point in a deployed position ready for charging a vehicle;

FIG. 2 shows a perspective view of the electric vehicle charging point of FIG. 1 in a retracted position below ground;

FIG. 3A shows a perspective view of a second embodiment of an electric vehicle charging point in a retracted position below ground;

FIG. 3B shows a perspective view of the electric vehicle charging point of FIG. 3A in a partially extended position, between the deployed and operative positions;

FIG. 3C shows a perspective view of the electric vehicle charging point of FIG. 3A in a deployed position ready for charging a vehicle;

FIG. 4 shows a post, link arm and cover plate, being parts of the electric vehicle charging point of FIG. 3A;

FIG. 5 shows the post and link arm of the electric vehicle charging point of FIG. 3A;

### DETAILED DESCRIPTION OF THE ILLUSTRATED EMBODIMENTS

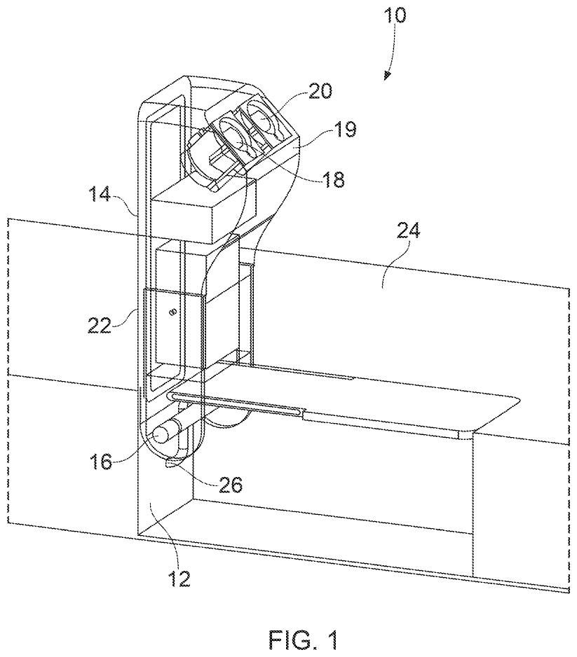

Referring firstly to FIG. 1, a deployable electric vehicle (EV) charging point is indicated generally at 10. The charging point 10 is shown in a deployed position. The charging point 10 includes a housing 12 and a charging post 14. The housing 12 is a substantially rectangular box, preferably made of metals or a composite, which is rigid and can be concreted into the ground.

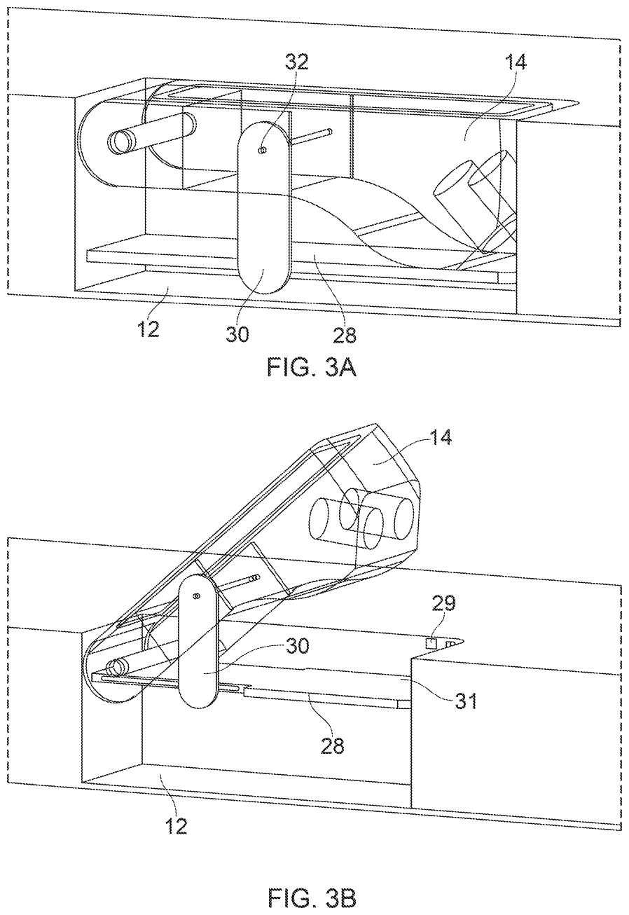

The post 14 is mounted to the housing 12 about an axle 16, providing a pivot, around which the post can move in and out of the housing 12, as indicated in FIGS. 3A to 3C. The axle is mounted to side walls of the housing.

The upper end of the post 14 is provided with an angled surface, for example at around 45 degrees to a central axis of the post. First and second charging sockets, or power distribution connection points 18, 20 are provided in the surface. The sockets are for receiving plugs of EV charging cables.

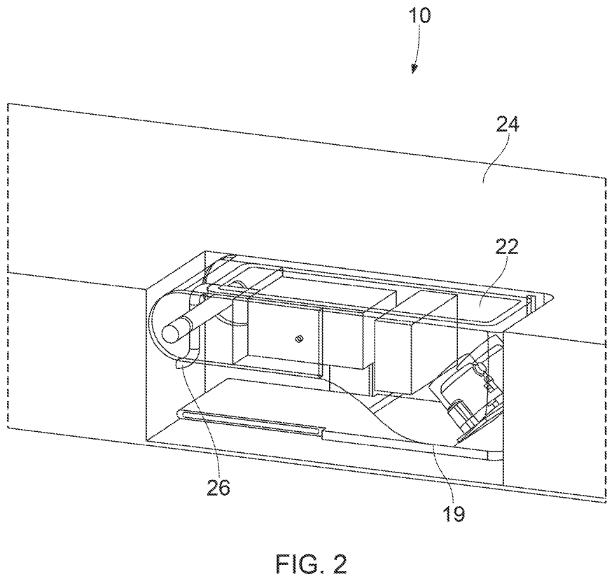

The angled position of the sockets facilitates easy connection of plugs with the sockets 18, 20. Furthermore, a cable supplying power within the post 14 can be easily routed without significant bending. The angled surface also acts to inset the sockets 18, 20 in relation to a forwardmost surface 19 of the post 14. The forwardmost surface 19 is in contact with the floor of the housing 12, or rather, in contact with a cover plate 28 which in turn is in contact with the floor of the housing 12, when the charging point is in the inoperative/stowed position as shown in FIG. 2. The contact surface ensures that a reaction is provided to the force of (for example) a person standing on the rear surface 22 of the post 14 when the charging point is stowed. This avoids transferring such a force through the drivetrain of the pivot mechanism. The angled surface which insets the charging sockets 18, 20 from the forwardmost contact surface 19 acts to protect the charging sockets 18, 20 and any controls while they are in the stowed position.

When the post 14 is in the stowed position, as shown in FIG. 2, a rear surface 22 of the post lies flush with upper edges of the housing 12 and level with the surrounding ground surface, indicated at 24. The rear surface 22 is intended to be weight bearing, and a person, for example, can walk onto it, for example, if it is in a pavement or walkway.

In the deployment of the post 14, a power supply cable 26 only has to bend to facilitate the rotary movement at the base of the post about the pivot. The maximum angle of rotation is 90 degrees, but will be reduced on a sloping surface by the angle of the surface to the horizontal. The housing is generally positioned with the pivot point at a lower point on the slope, to minimise the movement of the post and cable 26.

Deployment of the post 14 and movement of the post 14 to the retracted position is powered by an electric motor and a worm drive, which can be controlled remotely using a key fob remote control, for example. Alternatively, the post 14 may be controlled using an application on a mobile device, such as a mobile telephone. Control electronics ensure that the post rotates to the vertical position, irrespective of the angle of the housing 12 in the ground. This position may be detected by a sensor or may be programmed on installation. In this position, the rear side 22 of the post is vertically disposed.

In some embodiments, the sensor may detect the position of the cover plate 28. For example, a sensor may be positioned as indicated by numeral 29 in FIG. 3B. The sensor may be a non-contact sensor such as a hall-effect sensor 29 in the housing 12 and a magnet 31 imbedded in the cover plate 28. Positioning the sensor to detect the position of the cover plate 28 allows a simple position sensor to be used, which can be positioned on manufacture and does not need to be moved or set to take account of the slope on installation. Instead, the linkage between the post and the cover plate can be adjusted as explained in further detail below.

In order to prevent freezing of the axle 16, heating elements may be disposed inside the housing 12. The heating elements may be thermostatically controlled, or may be controlled using the key fob, as part of the actuation control.

A housing cover plate 28 is located in the base of the housing 12 when the post is in the inoperative position (FIG. 3A). This cover plate 28 rises up with the post to the top of the housing 12, as the post is deployed. The cover plate covers the space vacated by the post 14 in the housing 12, for security and safety. A link arm 30, for example, can synchronously lift the cover plate 28 as the post rotates. The link arm is connected to the post 14 about a pivot 32 and is connected to the cover plate by a pin and slot arrangement. Link arms may be provided on both sides of the post to add stability to the plate when deployed, as desired. Releasable securing means, such as latches, can be utilised to further support the periphery of the cover plate 28 in its upper position.

Preferably, the cover plate 28 is guided by tracks or other formations in the sides of the housing, so that it remains substantially parallel to the base of the housing 12 at all points along its travel. The length of the link arm 30 (or the effective length of the link arm between the post 14 and the cover plate 28) can be adjusted to account for slope in the road surface at a particular installation site, as explained in further detail below.

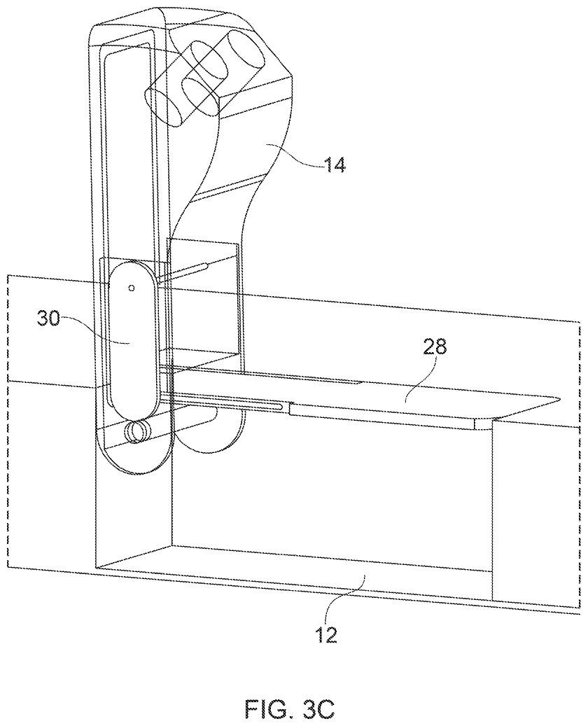

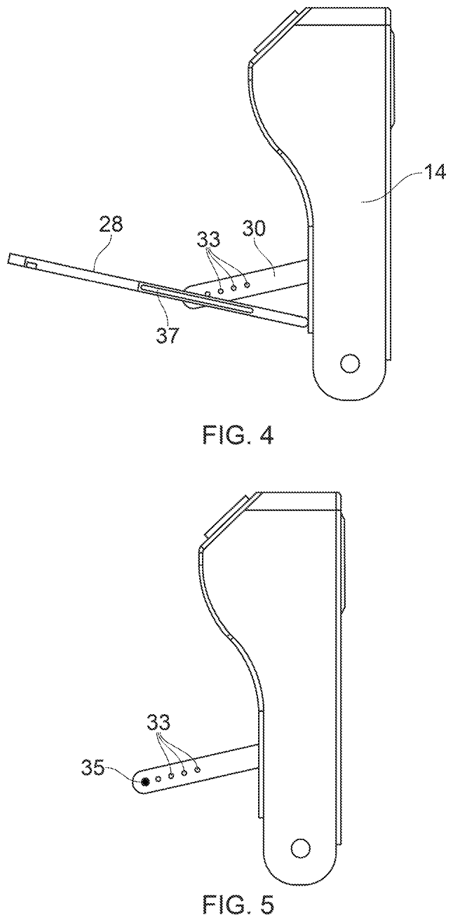

Referring to FIG. 4, the post 14, link arm 30 and cover plate 28 are shown without the housing (12). The link arm has a plurality of threaded holes 33 along its length, and a pin (35, FIG. 5) can be fixed into a selected one of the threaded holes 33. In this way, the position of the pin 35 along the length of the arm 30 can be selected. The pin 35 locates into a slot 37 running along a lateral side of the cover plate 28.

By selecting the position of the pin 35 along the length of the arm 30, the effective length of the arm 30 between the post 14 and the cover plate 28 may be adjusted. In this way, the angle between the cover plate and the post when the cover plate is at the top of its travel, flush with the road surface, is set. This allows the post to be set to rise to a vertical position irrespective of the slope of the road surface in any particular installation. The motor driving the post to move it to the deployed position may be controlled by a position sensor or limit switch which detects when the cover plate is at the top of its travel. Such a position sensor may be installed in the factory and does not need to be set or moved for a particular installation. Only a pin needs to be moved into a selected one of the threaded holes 33 along the arm 30. This is a very straightforward and reliable way of setting the angle for a particular installation.

It will be appreciated that the pivotal deployment of the charging point is beneficial because the ground depth of the housing can be limited, for example to around 300 mm, and the height of the post is not compromised. Furthermore, the post 14 can deploy vertically, irrespective of the angle of the ground surface 24, with minimal rotational movement, typically less than 90 degrees, which reduces stress on the cabling.

The charging post 10 may also have lights, one or more cameras, a microphone and other sensing equipment mounted to it for illumination, surveillance and damage detection purposes. This equipment may be connected to a network as part of a wider surveillance network. In particular, an accelerometer may be installed proximate the top of the post for detection of a vehicle impact. Detection of an impact may shut off the power supply to the post.

The embodiments described above are provided by way of example only, and various changes and modifications will be apparent to persons skilled in the art without departing from the scope of the present invention as defined by the appended claims.

What is claimed is:

1. A deployable electric vehicle charging point comprising a housing for burying substantially below a ground level, a post, and a socket mounted to the post, the socket being adapted to receive a plug of a vehicle charging cable, the post being mounted in the housing about a pivotal axis and being movable about the pivotal axis between a stowed position within the housing and an operative position, wherein the post is deployed substantially vertically in the operative position, irrespective of the incline of the housing, for enabling the electric vehicle charging point to be installed on an incline, and wherein the post has first and second lateral sides, the pivotal axis extending between the first and second lateral sides, the post further having a front-facing side and a rear-facing side, the rear-facing side having a substantially flat surface which in the stowed position forms an exposed upper surface at the ground level.

2. The deployable electric vehicle charging point as claimed in claim 1, in which an electric motor drives the post between the stowed and operative positions.

3. The deployable electric vehicle charging point as claimed in claim 1, in which a central axis of the power distribution connector is positioned at an angle to the post of between 20 degrees and 70 degrees.

4. The deployable electric vehicle charging point as claimed in claim 1, in which the socket is disposed on the front-facing side of the post.

5. The deployable electric vehicle charging point as claimed in claim 1, in which the forward-facing side of the post has a front contact surface which in the stowed position contacts a bottom of the housing, or contacts a part which in turn contacts the bottom of the housing.

6. The deployable electric vehicle charging point as claimed in claim 5, in which the socket is disposed on the front-facing side of the post and in which the socket is positioned inset rearwardly from the front contact surface of the post.

7. The deployable electric vehicle charging point as claimed in any preceding claim, in which a plate is provided for covering the housing when the post is in the operative position.

8. The deployable electric vehicle charging point as claimed in claim 7, in which the plate moves from a position within the housing to a position at the upper end of the housing as the post moves from the stowed position to the operative position and vice versa.

9. The deployable electric vehicle charging point as claimed in claim 8, in which the plate is coupled to the post by an arm, the arm being pivotally attached to the post at a first end of the arm, and an attachment on the arm being slidable in a slot running along a length of the plate.

10. The deployable electric vehicle charging point as claimed in claim 9, in which the position of the attachment along a length of the arm is movable or selectable.

11. The deployable electric vehicle charging point as claimed in claim 10, in which the attachment is a screw-threaded pin, and in which a plurality of screw-threaded holes are provided in positions along the length of the arm, the pin being attachable by fixing into a selected one of the screw-threaded holes.

12. The deployable electric vehicle charging point as claimed in claim 10, in which a limit switch or position sensor is provided, the limit switch or position sensor being positioned to detect when the cover plate is at an upper end of the housing.

13. The deployable electric vehicle charging point as claimed in claim 12, in which an electric motor is provided to drive the post between the stowed and operative positions, and in which the limit switch or position sensor is configured to switch off the motor when the cover plate is at the upper end of the housing, following movement of the post from the stowed position to the deployed position.

14. The deployable electric vehicle charging point as claimed in claim 12, in which the position sensor is a non-contact sensor and in which the position sensor is imbedded in a wall of the housing.

15. The deployable electric vehicle charging point as claimed in claim 13, in which the position sensor is a non-contact sensor and in which the position sensor is imbedded in a wall of the housing.

16. The deployable electric vehicle charging point as claimed in claim 1, in which the length of the housing is greater than the height of the housing.

17. The deployable electric vehicle charging point as claimed in claim 1, comprising a communication means for communicating with a network.

18. The deployable electric vehicle charging point as claimed in claim 1, comprising an alarm means for alerting person within the vicinity.

19. The deployable electric vehicle charging point as claimed in claim 1, in which a heater is provided for warming the post and/or housing.

20. The deployable electric vehicle charging point as claimed in claim 1, in which a charging cable holding means is provided for securing at least a portion of the electric vehicle charging cable.
